(19) United States
(12) Patent Application Publication
(10) Pub. No.: US 2006/0086921 A1
(43) Pub. Date: Apr. 27, 2006

(54) Wall hydrant assembly with a rotatable connector

(75) Inventor: William T. Ball, Colorado Springs, CO (US)

Correspondence Address: ZARLEY LAW FIRM P.L.C., CAPITAL SQUARE, 400 LOCUST, SUITE 200, DES MOINES, IA, 50309-2350, US

(73) Assignee: WCM INDUSTRIES, INC., Colorado Springs, CO (US)

(21) Appl. No.: 10/973,102

(22) Filed: Oct. 25, 2004

(51) Int. Cl. F16K 51/00

(52) U.S. Cl. 251/148

(57) ABSTRACT

A wall hydrant assembly having a body with a first passageway, a second passageway, and a conduit extending between the passageways where a connector is rotatably received within the first passageway to fluidly connect an inlet pipe to the body.

### BACKGROUND OF THE INVENTION

The present invention relates to a wall hydrandt and more specifically, to a wall hydrant having a rotatable connector.

When installing a wall mounted water hydrant the body of the hydrant must be connected to a water inlet pipe. Traditionally, wall mounted water inlet pipes hang down from the wall and a fixed connector is used to connect the body of the water hydrant to the inlet pipe. Occasionally, the inlet pipe will be angled or slanted because of improper installation or wear and tear on the pipe. Because of the slanting, the connector does not precisely align with the pipe. Consequently, to fit the connector to the pipe, the pipe must be pulled or bent until it is in alignment with the connector, which weakens and causes damage to the pipe.

Additionally, not all inlet pipes run in a downward direction. Inlet pipes can extend upwardly from the ground or from the side of the wall hydrant. As a result, a connector that can be adjusted is needed in order to connect the body of the wall hydrant to the inlet pipe. Otherwise, a connector specifically designed to accommodate an inlet pipe from a specific direction must be used. This causes a plumber to carry a variety of connectors to accommodate the different needs.

Accordingly there is a need in the art for a connector that is able to accommodate an inlet pipe that is slanted or misaligned. Additionally, there is a need in the art for a wall hydrant that can accommodate pipes that come from any direction.

Therefore, it a principle object of the present invention to provide a wall hydrant with a connector that is easy to install in a variety of situations.

Yet another object of the present invention is to provide a wall hydrant that uses a connector that is rotatably connected to the wall hydrant so that the connector may be rotated 360 degrees to accommodate all water inlet pipes.

It is yet another object of the present invention to provide a connector for a water hydrant that will rotate to ensure that a minimum amount of tension is placed on a water inlet pipe.

These and other objects, features, or advantages of the present invention will become apparent from the specification and claims.

### BRIEF SUMMARY OF THE INVENTION

The present invention is for a wall mounted water hydrant having a body with a first fluid passageway, a second fluid passageway, and a fluid conduit extending therebetween. Rotatably connected to the first passageway is a connector with a first portion that rotatably fits within a rearward end of the first passageway and a second portion that receives a fluid inlet pipe. A conduit extends through the first portion and the second portion to fluidly connect the inlet pipe with the first passageway.

### BRIEF DESCRIPTION OF THE DRAWINGS

FIG. 1 is a perspective view of the wall hydrant of the present invention connected to an inlet pipe;

FIG. 2 is an exploded view of the casing, connector, hydrant body, vacuum breaker and valve assembly of the present invention; and

### DESCRIPTION OF THE PREFERRED EMBODIMENTS OF THE INVENTION

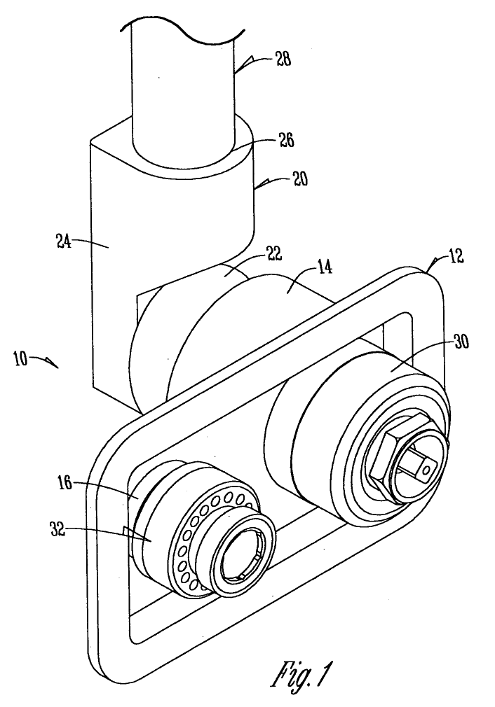

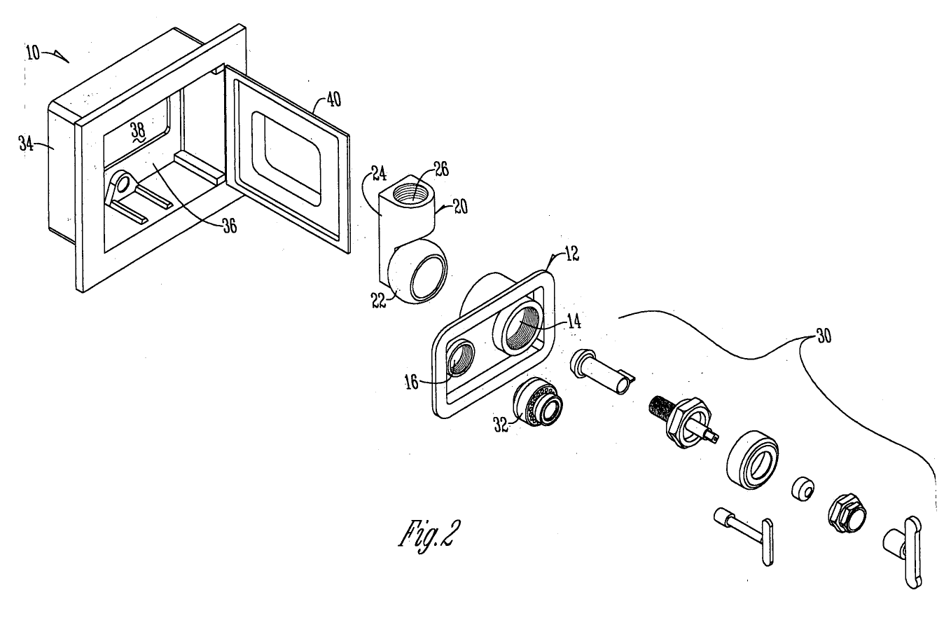

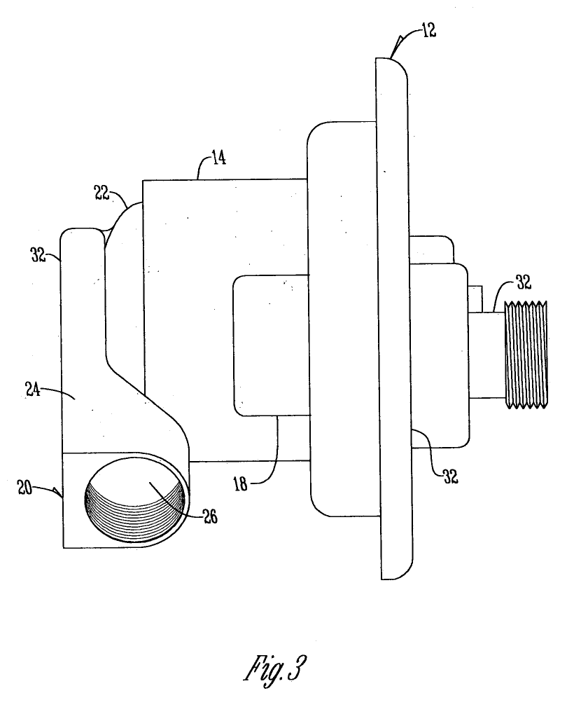

Referring to FIG. 1, the wall mounted hydrant assembly of the present invention is referred to by reference numeral 10. The wall-hydrant assembly has a body 12 having a first passageway 14 and a second passageway 16. Extending between and fluidly connecting the first passageway 14 to the second passageway 16 is a fluid conduit 18. Connected to the rearward end of the first passageway 14 is an L-shaped connector 20. The connector 20 has a first portion 22 that is received within the rearward end of the first passageway 14 and a second portion 24 that extends substantially perpendicular to the first portion 22. The first portion 22 is formed to fit snugly within the rearward end of the first passageway 14 such that the first portion 22 rotates 360° within the rearward end of the first passageway 14 while maintaining a water tight seal. Extending from the end of the second portion 24 through to the end of the first portion 22 is a fluid conduit 26. The conduit 26 at the end of the second portion 24 receives an inlet pipe 28 fluidly connecting the body 12 to a fluid source.

Fitted within the forward end of the first passageway 14 is a conventional valve assembly 30 that seats against the first portion 22 of the connector 20 to control the flow of water from the inlet pipe 28 through the connector 20 to the first passageway 14. Fitted within the forward end of the second passageway 16 is a conventional vacuum breaker 32.

To install, the body 12 of the wall hydrant assembly 10 is placed within a housing 34 having a back wall 36 wit an opening 38 such that the connector 20 extends through the opening 38 of the back wall 36. The housing is mounted in a wall in any conventional manner and optionally has a door 40 hingedly attached thereto to provide an aesthetically pleasing decorative cover. The connector 20 is then rotated within the rearward end of the first passageway 14 of the body 12 until the connector is aligned with the inlet pipe 28. Once aligned, the inlet pipe 28-is attached to the connector 20. Because the connector 20 is rotatable within the rearward end of the first passageway 14, the connector 20 can be aligned with the inlet pipe 28 regardless of the inlet pipe's 28 orientation to the wall hydrant assembly.

It will be appreciated that those skilled in the art that other various modifications could be made to the device without departing from the spirit in the scope of this invention. All such modifications and changes fall within the scope of the claims and are intended to be covered thereby.

What is claimed is:

1. A wall hydrant assembly comprising:
a body having a fluid passageway; and
a connector rotatably and fluidly connected to the fluid passageway.

2. The assembly of claim 1 wherein the connector can rotate 360 degrees.

3. The assembly of claim 1 wherein the connector is L-shaped.

4. A wall hydrant assembly for connection to a water inlet pipe, comprising:
a body having a first fluid passageway, a second fluid passageway and a conduit extending between the passageways; and
a connector rotatably connected to the first fluid passageway.

5. The assembly of claim 4 wherein the connector is L-shaped.

6. The assembly of claim 4 wherein the connector rotates 360°.

7. The assembly of claim 4 wherein the inlet pipe is connected to the assembly substantially perpendicular to the body.
